(19) United States
(12) Patent Application Publication
(10) Pub. No.: US 2006/0230899 A1
(43) Pub. Date: Oct. 19, 2006

(54) Longitudinal cutting machine with a cooled cutter blade

(76) Inventor: Rudolf Supe-Dienes, Overath (DE)

Correspondence Address: ROBERT W. BECKER & ASSOCIATES, 707 HIGHWAY 333, SUITE B, TIJERAS, NM, 87059-7507, US

(21) Appl. No.: 10/558,319

(22) PCT Filed: Mar. 19, 2004
(86) PCT No.: PCT/EP04/02871

§ 371 Date: Dec. 14, 2005

(30) Foreign Application Priority Data
May 22, 2003 (DE) 103 23 753.4

(51) Int. Cl. B26D 7/10

(52) U.S. Cl. 83/169; 83/171

(57) ABSTRACT

A longitudinal cutting machine for cutting a sheet of material conveyed through the cutting machine, comprising a cutter arrangement, provided with at least an upper cutter, for the sheet of material, which is conveyed through the cutter arrangement across the cutting point formed by the upper cutter, and at least one nozzle for conveying cooling medium onto a cutter blade of the upper cutter, wherein the nozzle extends or is distributed over a periphery or length of the cutter blade.

The invention relates to a longitudinal cutting machine for cutting a sheet of material that is conveyed through the longitudinal cutting machine, and includes a cutter arrangement, which is provided with at least one upper cutter, for the sheet of material, which is conveyed through the cutter arrangement across a cutting point formed by the upper cutter.

A longitudinal cutting machine having the aforementioned features is known from U.S. Pat. No. 3,185,010. With such longitudinal cutting machines, applications occur in connection with which the material that is to be cut adversely affects the cutting process to a greater or lesser degree as a function of the atmospheric temperature. Thus, for example, when cutting sheets of material that are coated with an adhesive, material residue frequently adheres to the blades, whereby also the temperature that rises at the cutting point due to the cutting friction can adversely affect the cutting result, which is particularly applicable to the high cutting speeds that are desired.

It is therefore an object of the present invention to provide a longitudinal cutting machine having the aforementioned features that enables a better cutting result for temperature sensitive materials, even at high cutting speeds.

The realization of this object, including advantageous embodiments and further developments of the invention, results from the content of the patent claims that follow this description.

The basic concept of the invention is that cooling medium can be supplied to the cutter blade of the upper cutter via at least one nozzle that is directed onto the upper cutter in such a way that during the cutting operation of the longitudinal cutting machine, the temperature of the cutter blade does not exceed a prescribed temperature.

Thus, for a longitudinal cutting machine, the invention is directed to cooling the cutter blade of the upper cutter by supplying it with a suitable cooling material, i.e. is directed to keeping the temperature of the cutter blade below a set temperature, even during the cutting process, so that even at very high cutting speeds, at which one can expect an increased heating of the sheet of material that is to be cut at the cutting point, adherence of substituents of the cut sheet of material on the cutter blade is prevented. Since only the cutter blade has to be kept cool, the energy consumption is also kept within appropriate limits. To the extent that nozzles are provided for the application of the cooling medium, such nozzles do not primarily provide a precise concentrated stream, but rather supply at least a laminar portion of the cutter blade that adjoins the cutting edge of the blade, for which purpose the corresponding nozzles can, for example, have a slotted discharge for the cooling medium.

Pursuant to one embodiment of the invention, a plurality of nozzles are provided that are distributed over the periphery of the circular cutter blade and are directed onto the cutter blade; alternatively, a single nozzle, embodied as a slotted nozzle, can extend over the periphery of the circular cutter blade.

In addition to embodying the upper cutter as a circular cutter, it is also conceivable to embody the cutter as a longitudinal cutter, and to this extent, pursuant to one embodiment of the invention, the cutter is embodied as a longitudinal cutter and is provided with a plurality of spaced-apart nozzles that are disposed over the length of the cutting edge of the longitudinal blade; alternatively, it is also possible to embody the cutter as a longitudinal cutter and to provide a single slotted nozzle that extends over the length of the cutting edge of the cutter blade.

Pursuant to one embodiment of the invention, the nozzle for the cooling medium that is to be conveyed therethrough is directed onto the inner side or edge of the cutter blade that during a shearing cut rests against the lower cutter; since in particular in this cutting region the occurrence of adherence of the sheet of material is most likely, here the invention is applied by cooling the inner side of the cutter blade.

Pursuant to one embodiment of the invention, the cutter blade of the upper cutter can be supplied with the cooling medium by nozzles disposed on both sides of the blade. Alternatively, or in addition thereto, especially the cutting edges of the blade can be cooled, for which purpose, pursuant to one embodiment of the invention, at least one nozzle is directed onto the cutting edge of the blade in a radial direction relative to the cutter blade.

Pursuant to one embodiment of the invention, where several cutter blades are slightly spaced from one another, a nozzle arrangement for supplying a plurality of cutter blades is provided. Such an arrangement is particularly suitable for very narrow cutting widths.

Pursuant to embodiments of the invention, a constant stream of cooling medium can be conveyed through the nozzles, or the nozzles are supplied with the cooling medium at periodic intervals.

To supplement the blades that are to be kept appropriately cool, pursuant to one embodiment of the invention, the sheet of material can be cooled at the cutting point itself by a nozzle that is oriented directly onto the cutting point.

Pursuant to one embodiment of the invention, the upper cutter, including the nozzle that is directed onto the cutter blade thereof, is surrounded by a housing, whereby a vacuum device for the cooling medium that is applied can be connected to the housing. To the extent that with an already addressed embodiment of the invention slightly spaced apart cutter blades are provided, the housing, along with a pertaining nozzle arrangement, can appropriately enclose a plurality of cutter blades.

With regard to the control of the use of the cooling medium, a temperature sensor can be associated with the cutter blade to detect the respective temperature of the upper cutter.

At least one nozzle can be oriented onto the sheet of material in that region thereof that is disposed upstream of where the sheet passes through the cutting point, so that as a supplement to the cooling of the cutter blade, the temperature of the sheet of material prior to entry into the cutter arrangement can also be lowered.

Pursuant to a particular embodiment of the invention, at least one nozzle can be directed onto that region of the already cut sheet of material that is disposed downstream of the cutting point and includes the cut edge in the sheet of material. To the extent that during a standstill of the longitudinal cutting machine the cut edges of the portions of the sheet of material that have just been separated by the cutter arrangement can again stick together, a cooling of the sheet of material that is also effected downstream of the cutter arrangement as viewed in the direction of transport of the sheet of material effects a certain embrittlement, so that when the sheet of material again starts to run, the cut portions of the sheet of material automatically separate from one another.

Pursuant to one embodiment of the invention, the lower cutter that is associated with the upper cutter is embodied as a lower cutter shaft having cutting edges disposed thereon, and the lower cutter shaft is designed for conveying the cooling medium therethrough.

The invention is also suitable for cutter arrangements that operate in a crimping cut mode, and to the extent that in this connection the upper cutter operates against a shaft, in addition to the cooling of the upper cutter the shaft can also be designed for conveying the cooling medium.

Pursuant to embodiments of the invention, the cooling medium can be cooled air, an inert cooling gas, a liquid nitrogen or also a liquid carbon dioxide; further suitable media can also be used within the scope of the invention.

To the extent that the embodiment of the upper cutter and/or lower cutter of metal also make possible an electrical cooling, pursuant to one embodiment of the invention the cooling device can also provide an electrical cooling of the upper cutter and/or lower cutter.

Embodiments of the invention will be described subsequently with the aid of the drawings, in which:

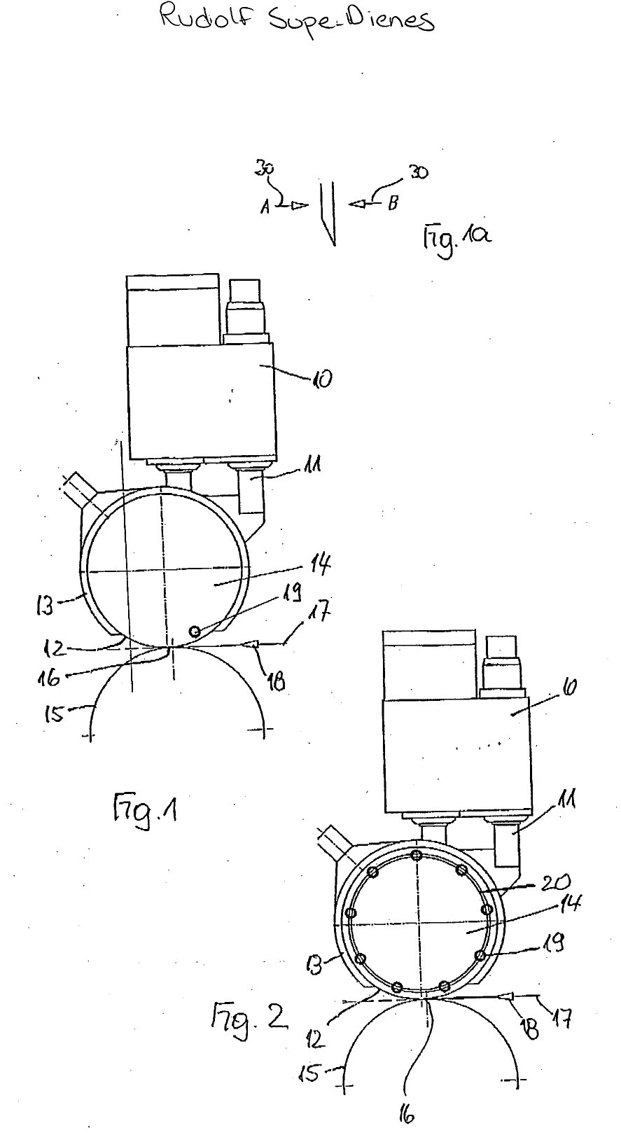

FIG. 1 shows a cutter arrangement comprising an upper cutter, which is supported on a cutter holder and is embodied as a circular cutter, and an associated lower cutter, with a cooling nozzle,

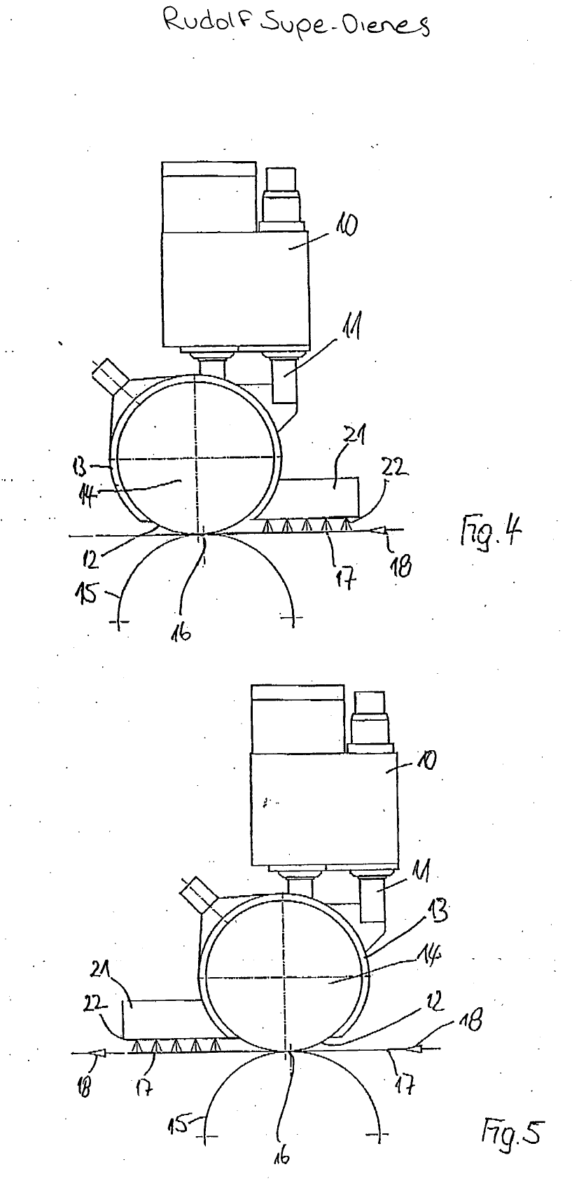

FIG. 2 shows the cutter arrangement of FIG. 1 with a plurality of individual nozzles and a single annular slotted nozzle,

FIG. 3 shows another embodiment of a cutter arrangement having upper cutters, including associated cooling nozzles, disposed on a cutter shaft,

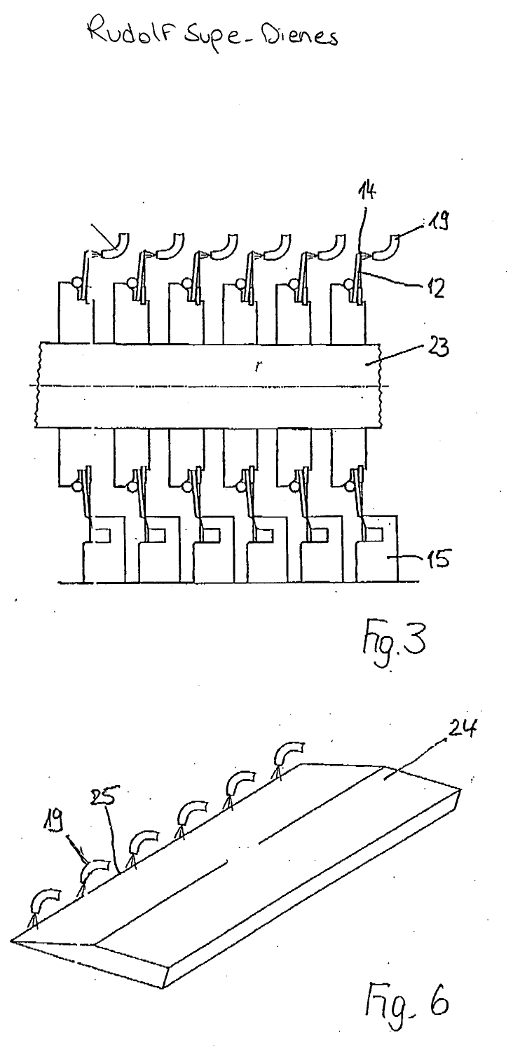

FIG. 4 shows the cutter arrangement of FIG. 1 with an additional cooling region for the sheet of material disposed prior to its passing through the cutter arrangement,

FIG. 5 shows the cutter arrangement of FIG. 1 with an additional cooling region for the sheet of material downstream of where it passes through the cutter arrangement,

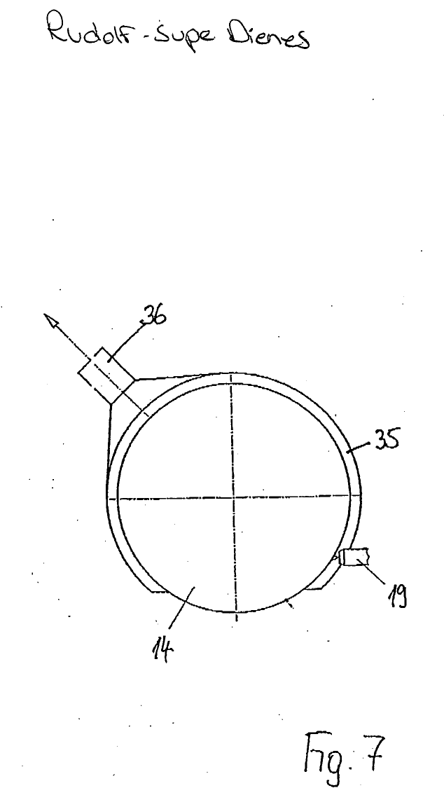

FIG. 6 shows a longitudinal cutter, with cooling nozzles, suitable for a cutter arrangement,

FIG. 7 shows a further embodiment of the cutter arrangement of FIG. 1 with a radially disposed nozzle and a housing having a vacuum device.

As can be initially seen from FIG. 1, supported on a blade or cutter holder 10 by means of a lowering mechanism 11 is an upper blade or cutter that is embodied as a circular cutter 12 and that is surrounded by a hand guard 13. Associated with the cutter blade 14 of the circular cutter 12 is a lower blade or cutter 15 in such a way that a cutting point 16 results though which a web or sheet of material 17 is guided in the direction of transport indicated by the arrow 18. Slightly upstream of the cutting point 16 as viewed in the direction of transport, a nozzle 19 is directed onto the cutter blade 14 in order, by passing a suitable cooling medium through the nozzle 19, to cool the cutter blade 14 before the associated cutting edge of the blade respectively reaches the cutting point 16 and hence comes into contact with the sheet of material 17. It is to be understood that the nozzle must respectively be disposed ahead of the cutting point 16 as viewed in the direction of transport of the sheet of material 17 through the cutter arrangement. As can be seen from the sketch of FIG. 1a, it would also be possible to dispose appropriate nozzles on both sides of the cutter blade 14 for conveying cooling medium thereto, so that, as indicated by the arrows 30, an appropriate cooling medium can be directed onto both sides of the cutter blade 14.

As shown in FIG. 2, a plurality of nozzles 19 can be distributed over the periphery of the cutter blade 14. In FIG. 2, to facilitate illustration, a further alternative is shown, according to which, instead of the individual nozzles 19, a circumferentially extending annular slotted nozzle 20 is provided, so that the entire periphery of the cutter blade 14 can receive the cooling medium stream via the annular slotted nozzle 20.

FIG. 3 illustrates a further embodiment of the invention, according to which a plurality of circular cutters 12, as the upper cutter, are disposed on a common cutter shaft 23 and in a shearing cut operate against the lower cutter 15, which has correspondingly associated blade cutting edges, whereby a respective nozzle 19 is associated with each of the circular cutters 12 in that region thereof that is disposed opposite the cutting point 16.

As can be seen from FIG. 4, an additional cooling of the sheet of material 17 can be effected ahead of the cutting point 16, as viewed in the direction of transport 18 of the sheet of material 17, by disposing a cooling bar 21 having a plurality of cooling nozzles 22 disposed therein parallel to the upper surface of the sheet of material 17. With this embodiment, in addition to the cooling of the cutter 12 that is still retained, a cooling of the sheet of material 17 is effected.

Pursuant to the embodiment of the invention illustrated in FIG. 5, a cooling bar 21 having appropriately associated cooling nozzles 22 extends behind or downstream of the cutting point 16, as viewed in the direction of transport 18 of the sheet of material 17, and is oriented parallel to the sheet of material 17. In this way, that region of the sheet of material 17 that includes the cut edge that has already been cut in the sheet of material 17 is cooled, thus achieving in a particularly advantageous manner a certain embrittlement of the sheet of material 17 by cooling the sheet of material downstream of the cutting point 16, so that after a possible standstill of the longitudinal cutting machine, when the sheet of material again starts running the cut portions of the sheet of material automatically separate from one another.

A further embodiment of the invention is shown in FIG. 6, according to which the blade that is to be cooled is embodied as a longitudinal blade 24, whereby distributed over the length of the cutting edge 25 of the blade is a plurality of nozzles 19 for cooling the longitudinal blade 24. Similar to the embodiment described in conjunction with FIG. 2, also with this embodiment, although not illustrated, a slotted nozzle that extends over the length of the cutting edge 25 of the longitudinal blade 24 can be provided for applying the cooling medium to the cutter blade.

Finally, a further embodiment of the invention is illustrated in FIG. 7, according to which a nozzle 19 is oriented radially relative to the cutting edge of the blade, so that cooling medium that is conveyed through the nozzle 19 flows against the cutting edge of the blade in the plane of the cutter blade. With this embodiment, a housing that surrounds the cutter blade 14 is also shown and is provided with a vacuum device 36 in order to draw off the cooled atmosphere that is produced about the cutter blade.

There are no limitations with regard to the use of cooling medium; for example, it would be possible to use an inert cooling gas, liquid nitrogen, liquid carbon dioxide, or even cooled air, and to convey them to the longitudinal cutting machine. Where air cooling is used, it would also be possible to first cool the air to the low temperature that is required in the region of the longitudinal cutting machine by providing expansion nozzles. With all of the cooling media, and with the corresponding control or fine metering of the use of the pertaining cooling medium, one must pay attention that no icing of the cutter blade, and also no formation of condensation water, occurs that would adversely disrupt the cutting process or the quality of the product.

The features of the subject matter of these documents disclosed in the preceding description, the patent claims, the abstract and the drawing can be important individually as well as in any desired combination with one another for realizing the various embodiments of the invention.

1-25. (canceled)

26. A longitudinal cutting machine for cutting a sheet of material conveyed through the cutting machine, comprising:
a cutter arrangement, which is provided with at least an upper cutter, for said sheet of material, which is conveyed through said cutter arrangement across a cutting point formed by said upper cutter); and
at least one nozzle for conveying a cooling medium onto a cutter blade of said upper cutter, wherein said at least one nozzle extends or is distributed over a periphery or length of said cutter blade.

27. A longitudinal cutting machine according to claim 26, wherein said cutter blade is a circular cutter blade, and wherein a plurality of nozzles are distributed over the periphery of said circular cutter blade.

28. A longitudinal cutting machine according to claim 26, wherein said cutter blade is a circular cutter blade, wherein said at least one nozzle is a single annular slotted nozzle, and wherein said nozzle is distributed over the periphery of said circular cutter blade.

29. A longitudinal cutting machine according to claim 26, wherein said cutter blade is a longitudinal blade having a cutting edge, and wherein a plurality of spaced-apart nozzles are distributed over the length of said cutting edge of said longitudinal cutter blade.

30. A longitudinal cutting machine according to claim 26, wherein said cutter blade is a longitudinal blade having a cutting edge, and wherein said at least one nozzle is a single slotted nozzle that extends over the length of said cutting edge of said longitudinal cutting blade.

31. A longitudinal cutting machine according to claim 26, wherein said cutter arrangement includes a lower cutter, and wherein said at least one nozzle for cooling medium conveyed therethrough is directed onto an inner side of said cutter blade that during a shearing cut rests against said lower cutter.

32. A longitudinal cutting machine according to claim 26, wherein cooling medium is adapted to be supplied to said cutter blade by nozzles disposed on opposite sides of said cutter blade.

33. A longitudinal cutting machine according to claim 26, wherein at least one nozzle is directed radially relative to a cutting edge of said cutter blade.

34. A longitudinal cutting machine according to claim 26, wherein a plurality of slightly spaced-apart cutter blades are provided, and wherein said at least one nozzle is part of a nozzle arrangement designed for supplying cooling medium to said plurality of cutter blades.

35. A longitudinal cutting machine according to claim 26, wherein one of said at least one nozzle is directed directly against said cutting point.

36. A longitudinal cutting machine according to claim 26, wherein a housing is provided that surrounds said upper cutter, including said at least one nozzle that is directed against said cutter blade of said upper cutter.

37. A longitudinal cutting machine according to claim 36, wherein a vacuum device for cooling medium that is applied is connected to said housing.

38. A longitudinal cutting machine according to claim 36, wherein a plurality of slightly spaced-apart cutter blades are provided, and wherein said housing, including an associated nozzle arrangement for said at least one nozzle, surrounds said plurality of said cutter blades.

39. A longitudinal cutting machine according to claim 26, wherein a temperature sensor is associated with said cutter blade for detecting a temperature of said upper cutter.

40. A longitudinal cutting machine according to claim 26, wherein at least one further nozzle is directed onto said sheet of material in a region thereof disposed upstream of where said sheet of material is conveyed across said cutting point.

41. A longitudinal cutting machine according to claim 26, wherein at least one further nozzle is directed against a region of an already cut sheet of material that is disposed downstream of said cutting point and includes a cut edge in said sheet of material.

42. A longitudinal cutting machine according to claim 26, wherein said cutting arrangement is provided with a lower cutter that is associated with said upper cutter, wherein said lower cutter is embodied as a lower cutter shaft having cutting edges disposed thereon, and wherein said lower cutter shaft is designed for conveying said cooling medium therethrough.

43. A longitudinal cutting machine according to claim 26, wherein said cutter arrangement is designed for operating in a crimping cut mode, wherein said upper cutter operates against a shaft, and wherein said shaft is designed for conveying said cooling medium therethrough.

44. The use of the longitudinal cutting machine of claim 26 for a temperature sensitive material, including the step of:
conveying said cooling medium through said at least one nozzle and onto said cutter blade to prevent a temperature of said cutter blade from exceeding a prescribed temperature during a cutting operation of said longitudinal cutting machine.

45. The use of the longitudinal cutting machine according to claim 44, wherein said step of conveying cooling medium comprises conveying cooling air, an inert cooling gas, liquid nitrogen, or liquid carbon dioxide.

46. The use of the longitudinal cutting machine according to claim 44, wherein said cooling medium is conveyed continuously or at periodic intervals through said at least one nozzle.

47. The use of a longitudinal cutting machine for cutting a sheet of temperature sensitive material conveyed through the cutting machine, wherein said cutting machine comprises a cutter arrangement, which is provided with at least an upper cutter, and optionally a lower cutter, for said sheet of material, which is conveyed through said cutter arrangement across a cutting point formed by said upper cutter, and wherein said cutting machine has an electrical cooling means for cooling at least one of said upper cutter and said lower cutter, including the step of:
cooling with said electrical cooling means to prevent a temperature of a cutter blade of said cutter from exceeding a prescribed temperature during a cutting operation of said longitudinal cutting machine.
